(19) United States
(12) Patent Application Publication
(10) Pub. No.: US 2025/0181931 A1
(43) Pub. Date: Jun. 5, 2025

(54) LOCAL GROUP-BASED FEDERATED LEARNING SYSTEM AND FEDERATED LEARNING CONTROL METHOD

(71) Applicant: Foundation of Soongsil University-Industry Cooperation, Seoul (KR)

(72) Inventors: Bongjun CHOI, Seoul (KR); Ajit KUMAR, Seoul (KR)

(73) Assignee: Foundation of Soongsil University-Industry Cooperation, Seoul (KR)

(21) Appl. No.: 18/726,534

(22) PCT Filed: Jan. 3, 2023
(86) PCT No.: PCT/KR2023/000064

§ 371 Date: Jul. 3, 2024

(30) Foreign Application Priority Data
Jan. 4, 2022 (KR) 10-2022-0000892

(51) Int. Cl. G06N 3/098

(52) U.S. Cl. CPC G06N 3/098

(57) ABSTRACT

A federated learning system comprises at least one central server and a plurality of local groups, wherein each of the plurality of local groups comprises one master node and a plurality of nodes, wherein the plurality of local groups are formed by the central server using information of a feature set (C) for federated learning.

### TECHNICAL FIELD

The present invention relates to a federated learning system and a federated learning control method based on a local group, and more particularly, to a federated learning system and a federated learning control method that perform federated learning by forming a local group through a trust value evaluation.

### BACKGROUND ART

Federated Learning is a machine learning technology that learns a global model in a decentralized data situation through collaboration between a plurality of local clients and a central server. Here, local clients can be, for example, IoT devices or smartphones.

This federated learning has been receiving a lot of attention since McMahan first published it in a paper in 2017, and was officially introduced on the Google AI blog in 2017, and is being applied to the Google Gboard.

In particular, methods for grouping and clustering learning have been proposed to reduce the non-iid (non-independent and identically distributed) problem caused by data scarcity and data imbalance.

However, even when grouping like this, there is a problem that learning accuracy is lowered compared to when learning is done centrally. There is also a problem that stability and performance are lowered due to clients that have insufficient resources or do not participate insincerely when sharing data between local clients configured within a local group. In addition, various security issues arise when maliciously attacking system vulnerabilities when sharing data within a local group.

### RELATED ART

Korean Patent Application Publication No. 10-2021-0121915

### DISCLOSURE

### Technical Issues

The present invention has been devised to solve the above problems, and the purpose of the present invention is to provide a federated learning system that forms a local group by trust value evaluation to improve data sharing within the group and perform federated learning.

Another purpose of the present invention is to provide a federated learning control method that forms a local group by trust value evaluation to improve data sharing within the group and perform federated learning.

### Technical Solution

A federated learning system according to one embodiment of the present invention comprises at least one central server and a plurality of local groups, wherein each of the plurality of local groups comprises one master node and a plurality of nodes, wherein the plurality of local groups are formed by the central server using information of a feature set (C) for federated learning.

In the federated learning system according to one embodiment of the present invention, each of the plurality of local groups further comprises a participation DB connected to the master node.

In the federated learning system according to one embodiment of the present invention, the information of the feature set (C) comprises any one of the trust score (T), execution capability (E), availability (A), participation (P), local data quality (Q), and device information (D).

A federated learning control method according to another embodiment of the present invention comprises (a) requesting, by a central server, information of a feature set (C) from a plurality of nodes to participate in federated learning; (b) designating, by the central server, a temporary master node among the plurality of nodes using the information of the feature set (C); (c) generating, by the central server, a plurality of local groups comprising the master node and nodes adjacent to the master node; and (d) receiving, by the central server, federated learning policy information from nodes constituting the local group through the master node.

In the federated learning control method according to another embodiment of the present invention, each of the plurality of local groups further comprises a participation DB connected to the master node in the (c).

In the federated learning control method according to another embodiment of the present invention, the information of the feature set (C) comprises any one of the trust score (T), execution capability (E), availability (A), participation (P), local data quality (Q), and device information (D).

In the federated learning control method according to another embodiment of the present invention, the trust score (T) is determined by a behavioral characteristic value (B) and a recommendation score (RB) of each of the plurality of nodes.

In the federated learning control method according to another embodiment of the present invention, the (b) designates the temporary master node using information on the trust score (T), execution capability (E), participation (P), and availability (A).

The features and advantages of the present invention will become more apparent from the following detailed description based on the attached drawings.

Prior to this, the terms or words used in this disclosure and claims should not be interpreted in their usual or dictionary meanings, but should be interpreted in their meanings and concepts that are consistent with the technical idea of the present invention based on the principle that the inventor can appropriately define the concept of the term to explain his or her own invention in the best way.

### Advantageous Effects

The federated learning system according to one embodiment of the present invention has a hierarchical structure comprising a local layer such as a plurality of local groups and a global layer comprising a master node of each local group and a central server, thereby reducing the number of updates, thereby yielding an effect of reducing the calculation and cost required for learning and minimizing possible security risks.

The federated learning control method according to another embodiment of the present invention generates a plurality of local groups while excluding inappropriate nodes using information of a feature set (C), thereby improving and maintaining reliability and performing efficient federated learning while minimizing security risks due to information exposure.

### DESCRIPTION OF DRAWINGS

These and/or other aspects will become apparent and more readily appreciated from the following description of the embodiments, taken in conjunction with the accompanying drawings in which:

FIG. 1 is a configuration diagram of a federated learning system according to one embodiment of the present invention;

FIG. 2 is a configuration diagram of an arbitrary local group constituting a federated learning system according to one embodiment of the present invention;

FIG. 3 is a flow chart for explaining a federated learning control method according to another embodiment of the present invention; and

FIG. 4 is an example of a source code showing a federated learning control method according to another embodiment of the present invention.

### DETAILED DESCRIPTION OF EMBODIMENTS

The purpose, specific advantages and novel features of the present invention will become more apparent from the following detailed description taken in conjunction with the accompanying drawings and preferred embodiments. In this disclosure, when adding reference numerals to components in each drawing, it should be noted that, as much as possible, the same components are given the same numerals even if they are shown in different drawings. In addition, although the terms first, second, etc. may be used to describe various components, the components should not be limited by the terms. The terms are used only for the purpose of distinguishing one component from another. In addition, in describing the present invention, if it is determined that a detailed description of a related prior art may unnecessarily obscure the gist of the present invention, the detailed description thereof will be omitted.

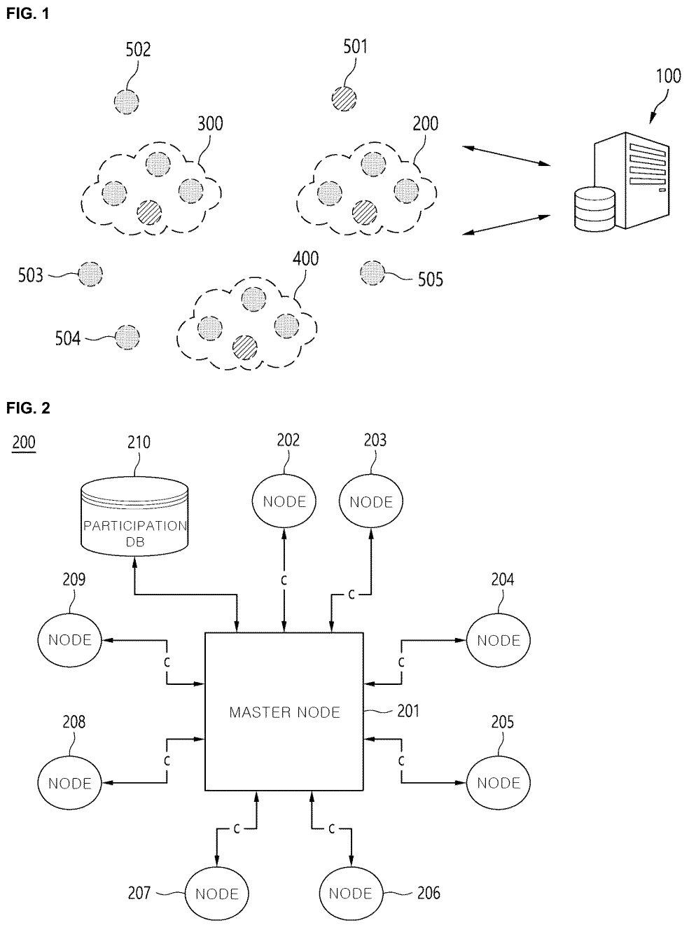

Hereinafter, a preferred embodiment of the present invention will be described in detail with reference to the attached drawings. FIG. 1 is a configuration diagram of a federated learning system according to an embodiment of the present invention, and FIG. 2 is a configuration diagram of an arbitrary local group constituting a federated learning system according to an embodiment of the present invention.

As shown in FIG. 1, a federated learning system according to an embodiment of the present invention comprises a central server 100 and a plurality of local groups 200, 300, 400, and each of the plurality of local groups 200, 300, 400 comprises one master node and a plurality of nodes. Here, the node may be a device having a neural network, such as an IoT (Internet of Things) device, another server, a smartphone, etc.

The central server 100 may form a plurality of local groups 200, 300, 400 using information of a feature set (C) for federated learning, and may designate a master node in each of the plurality of local groups 200, 300, 400. At this time, the central server 100 may exclude inappropriate nodes 501, 502, 503, 504, 505 that do not meet the conditions using the information of the feature set (C) from the group for federated learning. By excluding inappropriate nodes 501, 502, 503, 504, 505 and performing federated learning using a reliable local group 200, 300, 400, the reliability and performance of federated learning can be improved by improving the non-iid (non-independent and identically distributed) problem caused by data sparsity and data imbalance.

Each of the plurality of local groups 200, 300, 400 is configured to comprise, as shown in FIG. 2, one master node 201, a plurality of nodes 202, 203, 204, 205, 206, 207, 208, 209 connected to the master node 201, and a participation DB 210 connected to the master node 201.

The master node 201, a configuration specified using the information on the feature set (C) by the central server 100, may store information on the feature set (C) for each of the plurality of nodes 202, 203, 204, 205, 206, 207, 208, 209 forming a group or the learning results performed by each of the plurality of nodes 202, 203, 204, 205, 206, 207, 208, 209 in the participation DB 210, and transmit information on the feature set (C) or the performed learning results according to a request signal of the central server 100.

The participation DB 210 is designated by the central server 100 or the master node in the process of forming a plurality of local groups 200, 300, 400, and may store information on the feature set (C) newly updated for each of the plurality of nodes 202, 203, 204, 205, 206, 207, 208, 209 by the master node 201 or the learning results performed in each of the plurality of nodes 202, 203, 204, 205, 206, 207, 208, 209.

For the plurality of local groups 200, 300, 400 forming the group in this way, the central server 100 may exclude nodes within the group using the information on the feature set (C) newly updated for each of the plurality of nodes, thereby improving and maintaining reliability and minimizing security risks due to information exposure, while achieving efficient federated learning such as global model generation.

Accordingly, the federated learning system according to one embodiment of the present invention has a hierarchical structure comprising a local layer such as a plurality of local groups 200, 300, 400 and a global layer comprising a master node of each of the local groups 200, 300, 400 and a central server 100, and reduces the number of updates, thereby reducing the calculation and cost required for learning and minimizing possible security risks.

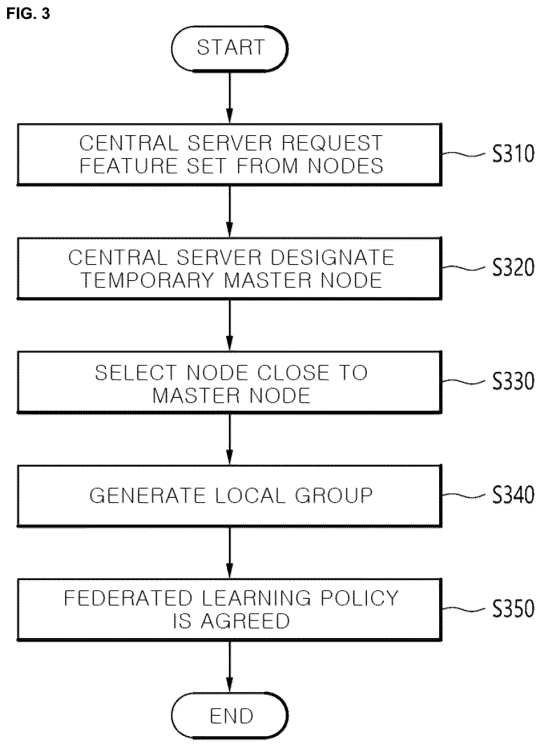

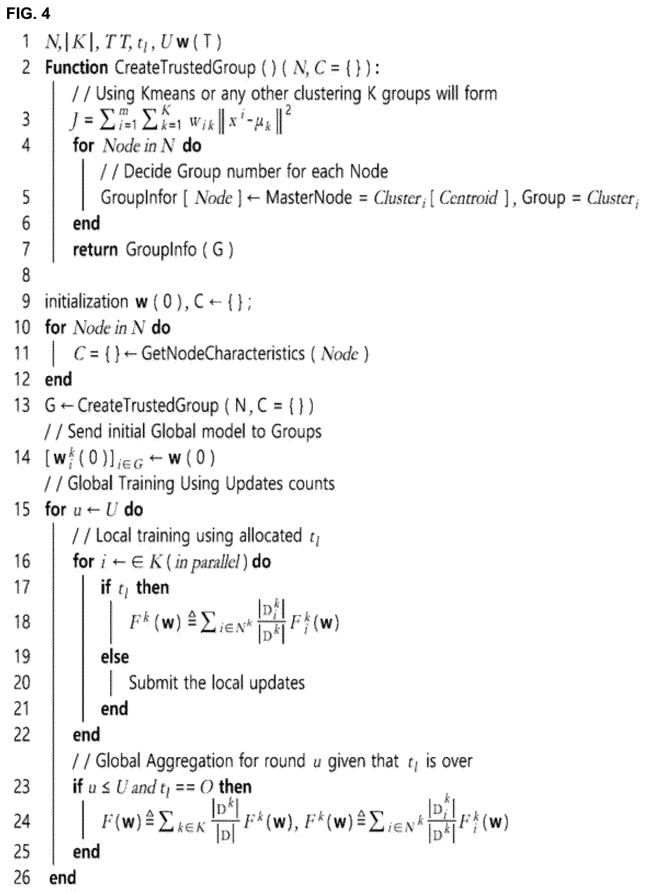

Hereinafter, a federated learning control method according to another embodiment of the present invention will be described with reference to FIGS. 3 and 4. FIG. 3 is a flowchart for explaining a federated learning control method according to another embodiment of the present invention, and FIG. 4 is an example of a source code showing a federated learning control method according to another embodiment of the present invention.

In the federated learning control method according to another embodiment of the present invention, the central server 100 first requests information on a feature set (C) from nodes to participate in federated learning (S310).

Specifically, the central server 100 may transmit a signal requesting information on a feature set (C) to nodes to participate in federated learning.

Each node that receives a signal requesting information on this feature set (C) generates information on the feature set (C) and transmits it to the central server 100.

At this time, the information on the feature set (C) is information that represents the characteristics of each node, and may be expressed as in [Equation 1] below.

$$C = \{ T , E , A , P , Q , D \} \qquad [ Equation 1 ]$$

The parameters that constitute the information of this feature set (C) may be defined as described in [Table 1] below.

TABLE 1

| Parameter of Feature Set (C) | Definition |
|---|---|
| T | Trust Score |
| E | Execution capacity |
| A | Availability |
| P | Participation in training |
| Q | Quality of the local dataset |
| D | Vector having device information |

The trust score (T) is determined by another node or another server, and initially, all nodes may have a score of, for example, 0.5. This trust score (T) may be updated by the master node 201 through an iterative process and stored in the participation DB 210. Nodes with low trust scores (T) may withdraw during the training process to maintain high reliability among nodes within the local group.

This trust score (T) may be expressed as [Equation 2] below, and may be stored in the participation DB 210 by the master node 201.

$$T = f ( B , RB ) = {w}_{1} \times B + {w}_{2} \times RB \qquad [ Equation 2 ]$$

Here, B is the behavioral characteristic value of the node, RB is the recommendation score, w₁ is the weight according to the importance of B, and ^{w}^{₂} is the weight according to the importance of RB.

The behavioral characteristic value (B) of the node is determined by using information such as the trust score (T), execution capability (E), participation (P), and availability (A) from the information of the feature set (C). In other words, the behavioral characteristic value (B) of the node can be normalized and calculated by the relational expression as shown in [Equation 3] below.

$$B = ( {t}^{s} + {e}^{s} + {a}^{s} + {PF}^{s} ) / n \qquad [ Equation 3 ]$$

Here, t^{s} is the normalized score of the node's trust score (T), e^{s} is the normalized score of the node's execution capability (E), a^{s} is the normalized score of the node's availability (A), PF^{s} is the normalized score of the node's participation frequency (PF), and n is the number of features for calculating the B value, which here means 4. In addition, the node's participation frequency (PF) is the participation frequency of each node that is stored and updated by the master node during the learning process, and the initial value is 0 for all nodes.

The recommendation score (RB) represents the degree of recommendation from other nodes, and may be expressed by the following relational expression [Equation 4].

$$RB = {B}_{avg} = ( {\sum }_{i = 1}^{m} {B}_{i} ) / m \qquad [ Equation 4 ]$$

Here, Bᵢ is the behavioral characteristic value of the surrounding node, and m represents the number of surrounding nodes.

The execution capability (E) is a value representing the processing capability of a given learning, and is calculated by comprehensively considering available computing and network resources such as computing speed, memory capacity, and communication speed.

Availability (A) refers to the time that the client wants to participate in the federated learning process.

The learning participation (P) is a value representing whether each node participates in the federated learning and has a value of 0 or 1.

The local data quality (Q) refers to the number of samples for each data class. If there are multiple classes, the data quality value of the entire class can be calculated using an average value calculation method such as the harmonic mean.

The device information (D) includes information such as the IP address, MAC address, protocol, and location of each node.

As the central server 100 receives information on the feature set (C) configured in this way from the nodes to participate in the federated learning, the central server 100 designates a temporary master node among the nodes (S320).

Specifically, the central server 100 may designate a node with a relatively higher value than other nodes as a temporary master node by using the information of the trust score (T), execution capability (E), participation (P), and availability (A) among the received information of the feature set (C).

After designating the temporary master node, the central server 100 selects a set number of nodes closest to the master node by using the information of the received feature set (C) (S330).

That is, the central server 100 can select a set number of nodes closest to the designated master node by using the location information of the device information (D), so that, for example, the nodes can be assigned to and selected as the closest local group by using the sum of the squares of the distances between the location (xⁱ) of the node and the location (μᵢ) of the designated master node by using the following [Equation 5].

$${w}_{ik} = \{ \begin{matrix}1 & if k = arg {min}_{j} {‖ {x}^{i} - {μ}_{j} ‖}^{2} \\ 0 & otherwise\end{matrix} \qquad [ Equation 5 ]$$

Here, w^{ik} is a distance variable, xⁱ is the location of the node, and μⱼ is the location of the master node.

$$J = {\sum }_{i = 1}^{m} {\sum }_{k = 1}^{K} {w}_{ik} {‖ {x}^{i} - {μ}_{k} ‖}^{2} \qquad [ Equation 6 ]$$

Here, m is the number of nodes, k is the number of groups, xⁱ is the location of the nodes, and μ_{K} is the location of the master node.

In addition to the grouping function (J) of the above-described [Equation 6], a plurality of local groups 200, 300, 400 can be generated by an algorithm including various grouping functions.

At this time, the central server 100 can re-designate each master node, and thus can readjust the master node of each local group using the following [Equation 7].

$${μ}_{k} = \frac{{\sum }_{i = 1}^{m} {w}_{ik} {x}^{i}}{{\sum }_{i = 1}^{m} {w}_{ik}} \qquad [ Equation 7 ]$$

Here, μ_{K} is the location of the master node, m is the number of nodes, w^{ik} is a distance variable, k is the number of groups, and xⁱ is the location of the node.

In this way, in the process of generating a plurality of local groups 200, 300, 400, the central server 100 or the master node can designate the participating DB (210).

After generating a plurality of local groups 200, 300, 400, the central server 100 receives federated learning policy information including agreements on the level of personal information protection and data sharing method from the nodes constituting each group through each master node (S350).

Upon receiving this federated learning policy information, the plurality of local groups 200, 300, 400 and the central server 100 perform federated learning, and the master node of each local group 200, 300, 400 transmits the learning results collected from other nodes constituting the local group to the central server 100.

The federated learning control method according to another embodiment of the present invention generates a plurality of local groups while excluding inappropriate nodes using the information of the feature set (C), thereby improving and maintaining reliability and minimizing security risks due to information exposure, while performing efficient federated learning.

Although the technical idea of the present invention has been specifically described according to the above-preferred embodiment, it should be noted that the above-described embodiments are for explanation and not for limitation.

In addition, those skilled in the art will be able to understand that various implementations are possible within the scope of the technical idea of the present invention.

### REFERENCE NUMERALS

100: central server 200, 300, 400: local group
201: master node
202, 203, 204, 205, 206, 20, 208, 209: node
210: participation DB

1. A federated learning system comprising:
at least one central server and a plurality of local groups,
wherein each of the plurality of local groups comprises one master node and a plurality of nodes,
wherein the plurality of local groups are formed by the central server using information of a feature set (C) for federated learning.

2. The system of claim 1, wherein each of the plurality of local groups further comprises a participation DB connected to the master node.

3. The system of claim 1, wherein information of the feature set (C) comprises any one of trust score (T), execution capability (E), availability (A), participation (P), local data quality (Q), and device information (D).

4. A federated learning control method comprising:
(a) requesting, by a central server, information of a feature set (C) from a plurality of nodes to participate in federated learning;
(b) designating, by the central server, a temporary master node among the plurality of nodes using the information of the feature set (C);
(c) generating, by the central server, a plurality of local groups comprising the master node and nodes adjacent to the master node; and
(d) receiving, by the central server, federated learning policy information from nodes constituting the local group through the master node.

5. The method of claim 4, wherein each of the plurality of local groups further comprises a participation DB connected to the master node in the (c).

6. The method of claim 4, wherein the information of the feature set (C) comprises any one of trust score (T), execution capability (E), availability (A), participation (P), local data quality (Q), and device information (D).

7. The method of claim 6, wherein the trust score (T) is determined by a behavioral characteristic value (B) and a recommendation score (RB) of each of the plurality of nodes.

8. The method of claim 6, wherein the (b) designates the temporary master node using information of the trust score (T), execution capability (E), participation (P), and availability (A).
